(19) United States
(12) Patent Application Publication
(10) Pub. No.: US 2012/0097550 A1
(43) Pub. Date: Apr. 26, 2012

(54) METHODS FOR ENHANCING WATER ELECTROLYSIS

(76) Inventor: Michael D. Lockhart, Charlottesville, VA (US)

(21) Appl. No.: 12/909,510

(22) Filed: Oct. 21, 2010

(51) Int. Cl. C25B 1/06; C25B 9/00

(52) U.S. Cl. 205/628; 204/273

(57) ABSTRACT

Apparatus and methods dissociate water into hydrogen and oxygen gases on a more efficient basis. By modifying the environmental conditions of the water through increased covalent and hydrogen bond movement, increasing the rate of self ionization, and with enhanced induced magnetic susceptibility, water electrolysis is achieved with reduced energy input. In the preferred embodiments, electrolysis is performed by the individual and balanced cumulative application of acoustic cavitation, a high-energy magnetic field to support enhanced magnetic susceptibility, and specific wavelength infrared energy to increase bond vibrational modes of water molecules. It has been discovered that the combination of acoustic cavitation, vibrational enhancement, and increased magnetic susceptibility significantly enhances proton-hopping and electric field fluctuations leading to an enhanced return on energy invested water electrolysis.

### FIELD OF THE INVENTION

This invention relates generally to the electrolysis of water and, in particular, to apparatus and methods that use a combination of acoustic cavitations, molecular vibrational enhancement, and increased magnetic susceptibility to reduce energy dissociation requirements associated with water electrolysis, thereby enhancing the process.

### BACKGROUND OF THE INVENTION

Extracting hydrogen gas from water is an important technology and may become increasingly critical as an alternative energy source. The normal basic energies required for water electrolysis are:
Anode (oxidation): 2 H20(l)→O2(g)+4H+(aq)+4e− Eₒox=−1.23 V
Cathode (reduction): 2 H+(aq)+2e−→H2(g) Eₒred=0.00 V

An individual water molecule has a large electric dipole, some magnetic susceptibility, and a potential for increased self ionization, etc. (see FIG. 1) Liquid water is a uniquely stable substance, owing the majority of its incredible properties to the combination of covalent and very strong hydrogen bonding. Liquid water has the same basic structure as solid water, with more motion. Electric field fluctuations in liquid water cause some molecular dissociation. The process takes place in about 150 fs: the bond system of water begins in a neutral state; random fluctuations in molecular motions occasionally (about once every 10 hours per water molecule) produce an electric field strong enough to break an oxygen-hydrogen bond, resulting in a hydroxide (OH⁻) and hydronium ion (H₃O⁺); the proton of the hydronium ion travels along water molecules by the Grotthuss mechanism (The protonic defect, proton-hopping-mechanism, which migrates through the hydrogen bond network through a series of hydrogen and covalent bond cleavage/formation); and a change in the hydrogen bond network in the solvent isolates the two ions, which are stabilized by solvation.

Unfortunately commercial applications of water electrolysis are inefficient and energy-intensive processes. Pure water is a fairly good insulator and under simple/normal electrolysis conditions creates little dissociated products. Currently technologies add a water-soluble electrolyte; the conductivity of the water then rises considerably. The electrolyte disassociates into cations and anions; the anions move towards the anode and neutralize the buildup of positively charged H+ ions and the cations move towards the cathode and neutralize the buildup of negatively charged OH− ions. This allows the continued flow of electricity. There are numerous problems associated with electrolytes within the reaction cell (An electrolyte anion with less standard electrode potential than hydroxide will be oxidized instead of the hydroxide, and no oxygen gas will be produced; where as a cation with a greater standard electrode potential than a hydrogen ion will be reduced instead and no hydrogen gas will be produced). In all water electrolysis cases where electrolytes are used, the gaseous product effluents are extremely corrosive and create numerous application problems.

Major competitors in the field of water electrolysis currently are using both high pressure and high temperature as tools for overall electrolytic enhancement. Ultra-high-pressure electrolysis is defined as operating in the 5000-10000 psi range. At ultra-high pressures the water solubility and cross-permeation across the membrane of H₂ and O₂ is affects hydrogen purity. Modified proton exchange membranes (PEMs) are used to reduce cross-permeation in combination with catalytic H₂/O₂ recombiners to maintain H₂ levels in O₂ and O₂ levels in H₂ at values compatible with hydrogen safety requirements.

The United States Department of Energy believes that high-pressure electrolysis will contribute to the enabling and acceptance of technologies where hydrogen is the energy carrier between renewable energy resources and clean energy consumers. Many companies are also pursuing high-pressure solutions including Mitsubishi with its High Pressure Hydrogen Energy Generator project.

High-temperature electrolysis is reportedly more efficient economically than traditional room-temperature electrolysis because some of the energy is supplied as heat, which is cheaper than electricity, and because the electrolysis reaction is more efficient at higher temperatures. In fact, at 2500° C., electrical input is unnecessary because water breaks down to hydrogen and oxygen through thermolysis. Such temperatures are impractical; proposed HTE systems operate between 100° C. and 850° C.

The efficiency improvement of high-temperature electrolysis is best appreciated by assuming the electricity used comes from a heat engine, and then considering the amount of heat energy necessary to produce one kg hydrogen (141.86 megajoules), both in the HTE process itself and also in producing the electricity used. At 100° C., 350 megajoules of thermal energy are required (41% efficient). At 850° C., 225 megajoules are required (64% efficient).

Given all of these energy delivery challenges, it is not surprising that numerous techniques have developed and tried to enhance water disassociation. U.S. patents have been granted on processes that use a magnetic field for film/bubble removal and more efficient mixing during the electrolysis process. Other approaches use acoustic energy or heating, including infrared sources.

Published U.S. Patent Application No. 2007/0065765, entitled “Energy Converting Device” discloses systems for generating a hydrogen-oxygen mixture or “Brown gas” with a reaction chamber in which electrodes are disposed. The reaction chamber is of a rotationally symmetrical shape with respect to an axis and at least certain regions of inner boundary surfaces of the reaction chamber in the region of a jacket of the reaction chamber are formed by inner electrode surfaces of the electrodes of the gas generator. An infrared source emits infrared radiation into a region of a reaction chamber to generate Brown gas in the form of bubbles. In one configuration, a magnet is oriented so that the magnetic induction in the region of the axis of the reaction chamber is anti-parallel with respect to the angular velocity or with respect to its direction. The process of forming the Brown gas also preferably takes place in conjunction with the additional effect of acoustic energy, which acts on the working medium in the form of ultrasound emitted by an acoustic source. The sound pressure from the acoustic source as well as the intensity of the infrared radiation from the infrared source and the magnetic induction 42 of the magnet are set by a control system.

While the '765 application does disclose a combination of magnetism, infrared energy and acoustics, the modalities are ineffective and do not exploit advantages to be gained from there use in a ‘symbiotic’ arrangement. In particular, for both the acoustic energy and the magnetic field, this reference is focused on fluid and gas movement, not on cavitations, micro bursts or enhanced magnetic susceptibility associated with hydrogen bond breakage.

Indeed, the '765 application is silent in regards to cavitation, focusing instead on a vortex which is induced and supported with acoustic waves and magnetic influence on an electrolyte. The focus is on using an electrolytic solution as opposed to any acid/base or salt induced ionized electron transport mechanism. Where there seems to be some overlap with respect to the use of infrared (IR), the description is vague, teaching only that the IR may be responsible for “ionization,” which is not the case. The IR exposure would cause some wavelength specific molecular motion, UV exposure would cause some ionization and/or very intense VIS/IR where a multi-photon effects could occur may also cause some ionization.

### SUMMARY OF THE INVENTION

This invention is directed to apparatus and methods to efficiently dissociate water into hydrogen and oxygen gases. By modifying the environmental conditions of the water through increased covalent and hydrogen bond movement, increasing the rate of self ionization, and with enhanced induced magnetic susceptibility, water electrolysis is achieved with reduced energy input. In the preferred embodiments, electrolysis is performed by the individual and balanced cumulative application of acoustic cavitation, a high-energy magnetic field to support enhanced magnetic susceptibility, and specific wavelength infrared energy to increase bond vibrational modes of water molecules. It has been discovered that the combination of acoustic cavitation, vibrational enhancement, and increased magnetic susceptibility significantly enhances proton-hopping and electric field fluctuations. As these are the primary processes through which water disassociates and enhanced water electrolysis results.

Apparatus for enhancing water electrolysis in accordance with the invention includes a water-holding vessel and a pair of oppositely charged electrolysis plates supported or in the vessel to initiate the electrolysis process. At least one strong, permanent magnet such as an N52 or other rare-earth magnet is used to generate a magnetic field with flux lines penetrating through the water contained in the vessel. An acoustic transducer generates acoustic energy sufficient to achieve cavitations of the water molecules, and a source of wavelength specific infrared (IR) energy is directed through the water in the vessel, such that the combined effects of the oppositely charged electrolysis plates, magnetic field, acoustic energy and infrared energy result in an enhanced disassociation of the water into hydrogen and oxygen gasses.

In the preferred embodiment, the magnet generates a magnetic field in the range of 6,500 to 15,000 Gauss. A plurality of magnets, on opposing sides of the vessel, for example, may be used to enhance field strength. The acoustic transducer preferably generates acoustic energy with energy densities on the order of 1 to 1018 kW/m3, and the IR source generates energy centered at 970 nm, 1200 nm, 1450 nm, 1950 nm, or combinations thereof.

Method aspects of the invention are also disclosed in detail.

### BRIEF DESCRIPTION OF THE DRAWINGS

FIG. 1 drawing of a water molecule and covalent bonding;

FIG. 2 is a simplified view of an electrolyzer cell design in accordance with the preferred embodiment of the invention;

FIG. 3 is a graph visualizing when the compression of bubbles occurs during cavitation, the heating is more rapid than thermal transport, creating a short-lived, localized hot spot;

FIG. 4 is a diagram showing how gravity collapse near an extended solid surface becomes non-spherical, creating high-speed jets of liquid and shockwaves at the surface;

FIG. 5 is a graph that shows the pressure dependence of water ionization at 25 degrees C.

FIG. 6 is a graph that shows the temperature dependence of water ionization at 25 MPa;

FIG. 7 is a drawing that illustrates a water molecule's three fundamental vibrational modes; namely, symmetric stretch, bending and asymmetric stretch; and

FIG. 8 is a graph that depicts how water shows strong absorptions in the infrared region of the spectrum.

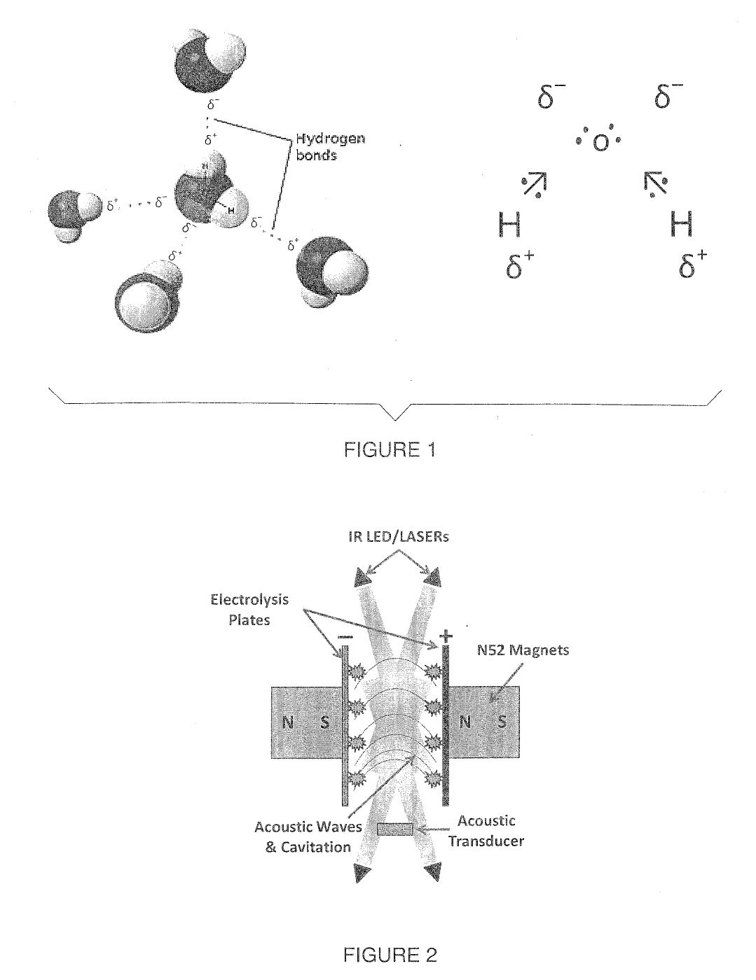

### DETAILED DESCRIPTION OF THE INVENTION

FIG. 2 is a schematic diagram identifying subsystems which will subsequently be described in detail. In contrast to the usual application electric current/voltage via plates 202, 204 to effectuate electrolysis, the overlapping modalities taught herein build on each other's qualities to provide an environment whereby water molecules will more readily dissociate. In other words, the energy reduction concepts are symbiotic in that they each enhance each other. The combined use of acoustic cavitation 206, vibrational enhancement with specific IR exposure 208, a strong surrounding magnetic field 210 together improve mass transport near the electrodes (plates) and movement within the electrolysis reaction chamber. The acoustic transducer placement enhances mass transport by inducing a convective flow within the reaction chamber.

### Acoustic Cavitation

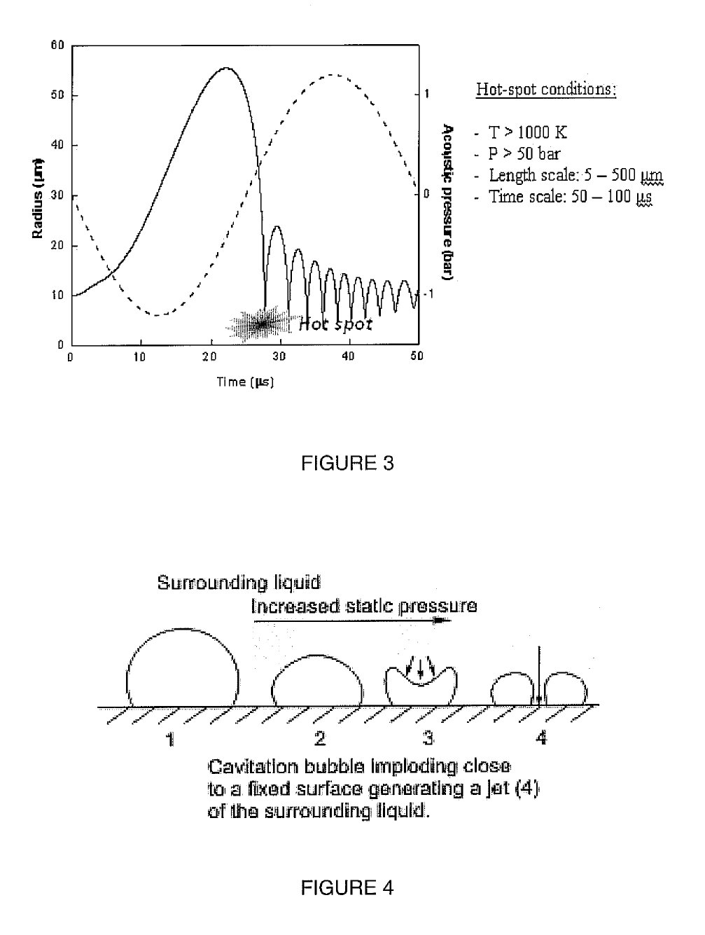

Acoustic cavitation creates micro bubbles. In this particular application the micro-bubbles form primarily on and around the electrodes. Pressure variations in the water are caused using sound waves in the 16 kHz-100 MHz range. The bubbles are created very rapidly and subsequently collapse rapidly as well. The bubble collapse in the water results in an enormous concentration of energy from the conversion of the kinetic energy of liquid motion into heating of the contents of the bubble (water vapor). When the compression of bubbles occurs during cavitation, the heating is more rapid than thermal transport, creating a short-lived, localized hot spot (see FIG. 3).

The collapse of bubbles in a multi-bubble cavitation field can produce hot spots with effective temperatures of up to ˜5000° K, pressures of up to ˜1000 atmospheres, and heating and cooling rates above 1000° K/s. Cavitation creates an extraordinary physical and chemical environment in otherwise cold liquids. Cavity collapse near an extended solid surface becomes non-spherical; it creates high-speed jets of liquid into the surface, and creates shockwaves at the surface (see FIG. 4).

Since energy is only supplied to micro-bubble formation and the entire water volume is not energized, the return on energy invested (energy requirements) is excellent. At the elevated temperature and pressures, thermolysis of water can occur, meaning that the water breaks down on its own under extreme heat and pressure. The process focuses on acoustic cavitation energies sub-thermolysis conditions, where an energy balance between acoustic energy input, electrical energy input and hydrogen production is established.

Cavitation results in very high energy densities of the order of 1 to 1018 kW/m3. Pure water is a good insulator since it has a low autoionization, Kw=10×10-14 at room temperature and thus pure water conducts current poorly, 0.055 μS·cm-1. Unless a very large potential is applied to cause an increase in the autoionization of water, the electrolysis of pure water proceeds very slowly limited by the overall conductivity. In this case a very large thermal and pressure energy is applied well above the autoionization energies required for water dissociation, reducing the insulator effect and increasing auto-ionization and electrolysis potential.

For the water monomers in the gas phase (inside the bubble), the lowest dissociation asymptote of the water molecule corresponds to the homolytic dissociation (formation of free radicals). The free radicals are generated in the process due to the high energy dissociation of vapors trapped in the cavitating bubbles. This results in the significant intensification of radical formation and subsequent dissociation in an electric field.

H₂O→O*+2H*

In the condensed (liquid) phase surrounding the bubbles, the energetics are significantly lower and the lowest dissociation asymptote correlates with the heterolytic products (ion products).

H₂O→O⁻+2H⁺

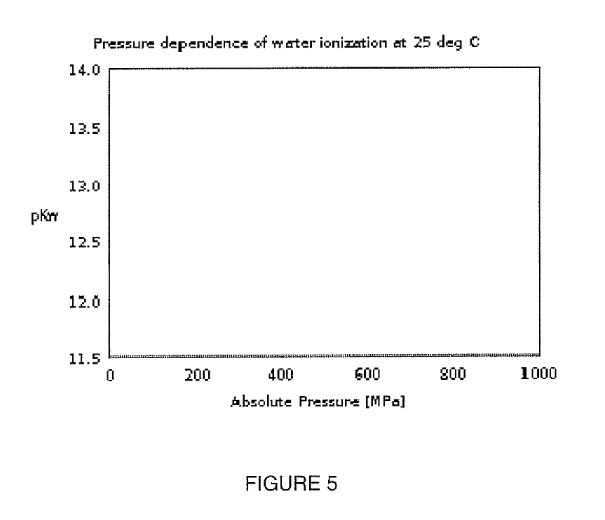

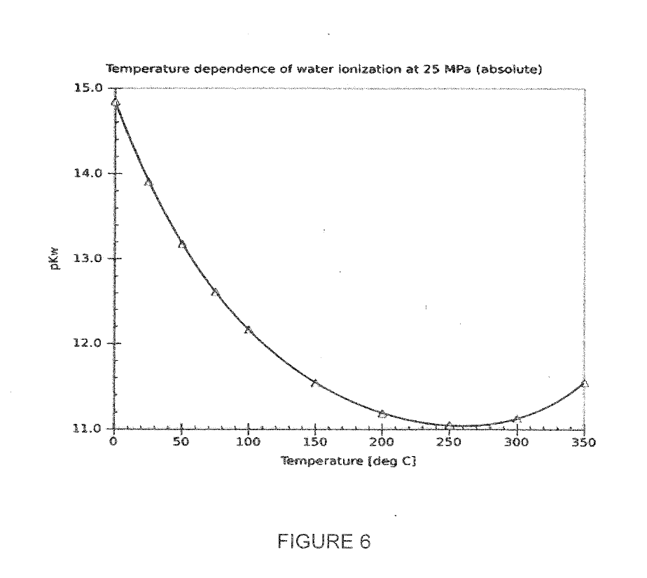

Both free radical formation and increased ionization promotes enhanced electrolysis. FIG. 5 is a graph that shows the pressure dependence of water ionization at 25 degrees C. FIG. 6 is a graph that shows the temperature dependence of water ionization at 25 MPa. If electrolysis is looked at from ionization potential, the pKw=−log 10 Kw, which at SATP=14. The negative log of the water ion content, pKw varies with temperature. As temperature increases, pKw decreases; and as temperature decreases, pKw increases, indicting an increase in the ionization of water as temperatures rise (for temperatures up to about 250° C.). There is also a small dependence on pressure where ionization increases with increasing pressure. Acoustic cavitation can efficiently provide both of these environments (high temperature and high pressures) in a micro-environment which stabilizes secondary effects, reduces energy input requirements and reduces overpotential requirements.

Electrolysis requires more extreme potentials than what would be expected based on the cell's totally reversible reduction potentials, or “over potential.” The most common cause of over potential is the reversible reaction of oxygen and hydrogen to produce water. This excess potential accounts for various forms of over-potential by which the extra energy is eventually lost as heat. Acoustic cavitation also significantly reduce or eliminate in some cases the requirements for electrolytes. This is done by significantly increasing auto-ionization and radical formation.

As an added benefit according to the invention, acoustic cavitation results in the generation of local turbulence and liquid micro-circulation (acoustic streaming, jets) in the reactor, enhancing the rates of mass/ion/gas transport processes. These jets activate the surface (catalyst) and increase mass transfer from the surface by disruption of the interfacial boundary layers and dislodging the already dissociated gases occupying the active sites.

Vibrational Enhancement with Specific IR Exposure

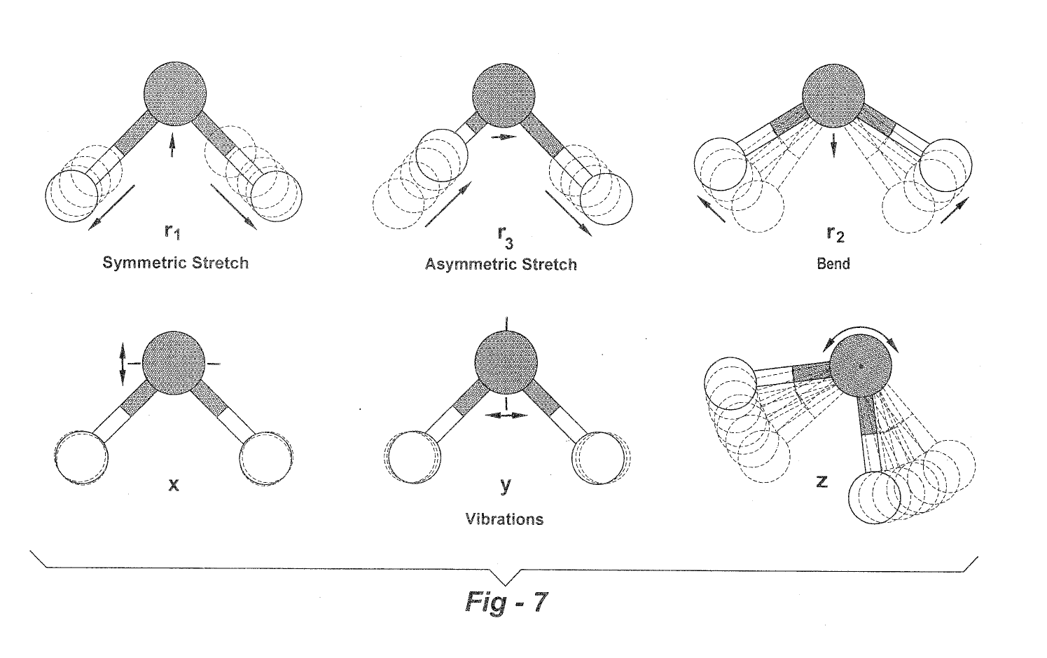

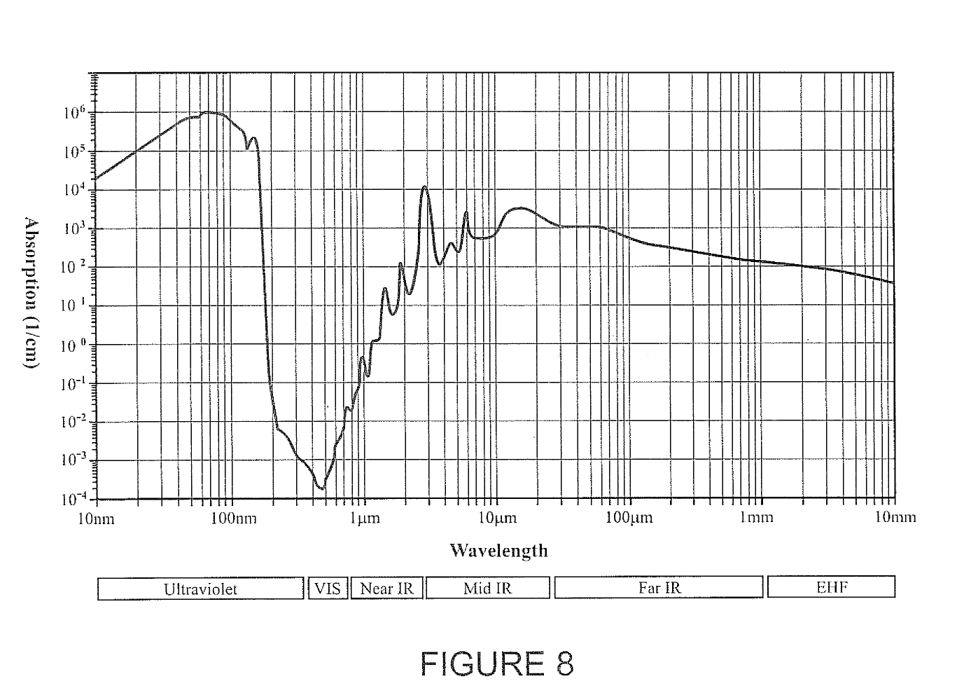

The water molecule is strong due its simple and strong covalent and hydrogen bonding network. Disrupting the “normal” covalent and relatively very strong hydrogen bonding network that is responsible for all of waters unique properties is key to reducing dissociation energy requirements. Water shows strong absorptions in the IR (FIG. 8). These IR absorption bands of water are related to molecular vibrations involving various combinations of the water molecule's three fundamental vibrational modes (FIG. 7):

V1: symmetric stretch

V2: bending

V3: asymmetric stretch

The absorption feature centered near 970 nm is attributed to a 2V1+V3 combination, the one near 1200 nm to a V1+V2+V3 combination, the one near 1450 nm to a V1+V3 combination, and the one near 1950 nm to a V2+V3 combination.

The spectral absorption features of liquid water are shifted to longer wavelengths with respect to the vapor features by approximately 60 nm. The rotations of liquid water tend to be hindered by hydrogen bonds, leading to librations (rocking motions). Stretching vibrations are shifted to a lower frequency while the bending frequency increases due to hydrogen bonding.

Both liquid and vapor (inside the acoustically induced bubbles) phases of water exist in the acoustic cavitation environment. Semi-broad spectral (10's to 100's of nanometers) excitation of waters vibrational frequencies, especially those which are in response to hydrogen bond induced librations reduces electrical energies required for water electrolysis.

### Enhanced Magnetic Susceptibility

Water is a diamagnetic material. Diamagnetism is the property of an object which causes it to create a magnetic field in opposition of an externally applied magnetic field, thus causing a repulsive effect. By applying a strong external magnetic field, the orbital velocity of electrons around the water nuclei are changed. These changes affect the magnetic dipole moment of the water molecule in the direction opposing the external field. In conjunction with vibrational enhancement and cavitation, this opposition to the external magnetic field creates a partial artificial alignment of the now vibrationally and electronically stressed water molecule further enhancing water electrolysis.

In electromagnetism the magnetic susceptibility is the degree of magnetization of a material in response to an applied magnetic field. Water has a relative magnetic permeability that is less than 1, thus a magnetic susceptibility which is less than 0, and is repelled by magnetic fields. However, since diamagnetism is such a weak property its effects are not observable in every-day life.

The magnetic susceptibility of water is =−9.05×10-6. Placing the electrolysis cell in a strong (permanent) magnetic field (6,500 to 15,000 gauss or more surface field strength), in conjunction with vibrational enhancement and cavitation increases the magnetic susceptibility, decreases the energies required for dissociation and again enhances water electrolysis.

1. Apparatus for enhancing water electrolysis, comprising:
a water-holding vessel;
a pair of oppositely charged electrolysis plates supported or in the vessel;
a magnet generating a magnetic field with flux lines penetrating through the water contained in the vessel;
an acoustic transducer generating acoustic energy causing cavitations of the water molecules; and
a source of infrared (IR) energy directed through the water in the vessel; and
wherein the combined effects of the oppositely charged electrolysis plates, magnetic field, acoustic energy and infrared energy result in an enhanced disassociation of the water into hydrogen and oxygen gasses.

2. The apparatus of claim 1, wherein the magnet generates a magnetic field in the range of 6,500 to 15,000 Gauss.

3. The apparatus of claim 1, wherein the magnet is an N52 or other permanent, rare-earth magnet or electric magnet.

4. The apparatus of claim 1, including a plurality of magnets on opposing sides of the vessel.

5. The apparatus of claim 1, wherein the acoustic transducer generates acoustic energy densities on the order of 1 to 1018 kW/m3.

6. The apparatus of claim 1, wherein the IR source generates energy centered at 970 nm, 1200 nm, 1450 nm, 1950 nm, or combinations thereof.

7. Apparatus for enhancing water electrolysis, comprising:
a water-holding vessel;
a pair of oppositely charged electrolysis plates supported or in the vessel;
one or more permanent, rare-earth magnets generating a magnetic field in the range of 6,500 to 15,000 Gauss with flux lines penetrating through the water contained in the vessel;
an acoustic transducer generating acoustic energy densities on the order of 1 to 1018 kW/m3, resulting in cavitations of the water molecules;
a source of infrared (IR) energy directed through the water in the vessel, the IR energy being centered around 970 nm, 1200 nm, 1450 nm, 1950 nm, or combinations thereof; and
wherein the combined effects of the oppositely charged electrolysis plates, magnetic field, acoustic energy and infrared energy result in an enhanced disassociation of the water into hydrogen and oxygen gasses.

8. A method of enhancing water electrolysis, comprising the steps of:
providing a water-holding vessel;
generating a partial disassociation of the water using a pair of oppositely charged electrolysis plates supported or in the vessel;
directing a strong magnet field through the water contained in the vessel;
generating acoustic energy sufficient to cause cavitations of the water molecules; and
orienting a source of infrared (IR) energy through the water in the vessel, such that the combined effects of the oppositely charged electrolysis plates, magnetic field, acoustic energy and infrared energy result in an enhanced disassociation of the water into hydrogen and oxygen gasses.

9. The method of claim 8, wherein the magnet generates a magnetic field in the range of 6,500 to 15,000 Gauss.

10. The method of claim 8, wherein the magnet is an N52 or other permanent, rare-earth magnet or electric magnet.

11. The method of claim 8, including a plurality of magnets on opposing sides of the vessel.

12. The method of claim 8, wherein the acoustic transducer generates acoustic energy densities on the order of 1 to 1018 kW/m3.

13. The method of claim 8, wherein the IR source generates energy centered at 970 nm, 1200 nm, 1450 nm, 1950 nm, or combinations thereof.

14. A method of enhancing water electrolysis, comprising the steps of:
providing a water-holding vessel;
generating a partial disassociation of the water using a pair of oppositely charged electrolysis plates supported or in the vessel;
directing a magnetic field in the range of 6,500 to 15,000 Gauss through the water contained in the vessel;
generating acoustic energy densities on the order of 1 to 1018 kW/m3 sufficient to cause cavitations of the water molecules; and
orienting a source of infrared (IR) energy through the water in the vessel, the IR energy being centered around 970 nm, 1200 nm, 1450 nm, 1950 nm, or combinations thereof, such that the combined effects of the oppositely charged electrolysis plates, magnetic field, acoustic energy and infrared energy result in an enhanced disassociation of the water into hydrogen and oxygen gasses.
